(19) United States
(12) Patent Application Publication
(10) Pub. No.: US 2011/0198408 A1
(43) Pub. Date: Aug. 18, 2011

(54) METHOD OF FUEL INJECTION (VARIANTS)

(76) Inventor: Evgeny Nikolaevich Zakharov, Moscovskaya oblast (RU)

(21) Appl. No.: 12/998,372

(22) PCT Filed: Oct. 13, 2009
(86) PCT No.: PCT/RU2009/000536

§ 371 Date: Apr. 13, 2011

(30) Foreign Application Priority Data
Oct. 14, 2008 (RU) 2008140445

(51) Int. Cl. B05B 5/025

(52) U.S. Cl. 239/3

(57) ABSTRACT

The method is intended for fuel injection systems, for atomizing different fluids. In the method, which involves pumping a jet of fluid through a nozzle orifice while producing an electrical spark discharge in the fluid flow, the inlets of the nozzle passages are arranged along lines that pass between the discharging surfaces of electrodes. The nozzle passages are opened prior to an electrohydraulic discharge and are closed after fuel injection, the process of opening and closing the nozzle passages being controlled. Fuel is pumped at least between the electrodes inside the electrical discharge nozzle, and the pressure of the pumped fuel is kept close to the pressure in the injection volume. The quantity of fuel to be injected is adjusted by varying the distance between the end face of a high-voltage electrode and an earth electrode and/or by changing the discharge energy. In order to provide stable and high fuel characteristics, gases and some other discharge products are removed from the fuel. In order to achieve high parameters of the voltage supplied by a high-voltage energy storage unit (delay, voltage, length, slope and frequency), a high-voltage switch is inserted into the electrical circuit that operates the electrical discharge nozzle.

### FIELD OF THE INVENTION

The invention belongs to the domain of hydraulics and electrical engineering and may be used in the development of fuel injection systems for various classes of engines, in various boiler plants, and also for spraying of various liquids when it is necessary to use the properties acquired by liquids in the electrohydraulic discharge process (for instance, in order to obtain powerful flows of highly dispersed and (or) modified in the process of liquid discharges).

### BACKGROUND ART

Various methods and devices are known for creation of high pressure of the fuel injected into combustion chambers of internal combustion engines (ICE), diesels in particular. The direct-action and storage battery-operated fuel systems (FS) are known. The fuel systems of these two types may be equipped both with traditional mechanical and electronically-operated electrical control devices [1]. The FS purpose is to provide the injection of necessary amount of fuel at the required moment and with the possibly high pressure [2, p. 256]. Thus the low-toxic, high-efficiency and noiseless operation of the ICE is ensured.

The high-pressure storage battery-operated fuel systems (SBOFS) [2] are the most advanced ones. They are capable of providing the injection at an injection pressure of about 2000 bar within 1 to 2 ms [2, p. 301]. With a diesel engine running at 5000 r/min (existing maximum rotational speed of motor car diesels [3, p. 14]) such injection time corresponds to 30-60 degrees of the crankshaft turn (CST). Correspondingly, with the higher rotational speed of the engine the injection time will correspond to the CST greater angle. Apart from the injection time, the time of fuel carburetion (evaporation and mixing) and combustion are required in order to provide for working process.

As it is known, fuel evaporation rate after injection is proportional to general surface of droplets, while the surface of all the droplets, obtained when spraying a certain volume of liquid, increases in reverse proportion to their diameter [3, p. 50].

Heating and evaporation intensity of the droplets depends on the relative velocity of droplet movement in the air, which in its turn depends on the injection pressure.

Time of the droplet total evaporation is directly proportional to its squared initial diameter, i.e. it quickly reduces as the spraying fineness improves; reciprocally proportional to the diffusion coefficient, which in its turn increases with the temperature increase and decreases with the pressure rise; reciprocally proportional to fuel vapor pressure, which quickly builds up with equilibrium evaporation temperature [3, p. 52] and takes no more than 10 ms (about 30° of the CST) for diesel fuel injection pressure of 2000 bar starting from the beginning of the injection.

The evaporation rate considerably increases after beginning of the combustion process due to the temperature sharp increase in the combustion chamber as well as turbulence increase. Even in the process of fuel evaporation, as it is mixed with air and the necessary values of the excess air factor in some clusters of the above-the-piston space are achieved, the fuel combustion process is initiated at the required temperature level (as a result of compression or spark) sharply accelerating the process of its evaporation.

The time of mixing the fuel vapors with air, that is the formation of combustible mixture proper, depends on the flow turbulence and is considerably shorter than the evaporation time.

Thus, it can be considered that the mixture preparation and combustion duration is determined by the fuel injection process time.

As it is known from practice, the fuel injection phase under full load corresponds approximately to 20-40° of the CST [3, p. 305] for the existing diesels. For the advanced diesels it must be much less.

To reduce the injection time, it is necessary to either increase nozzle flow section (which is impermissible because it leads to considerable increase of the fuel droplets size and decelerates fuel evaporation) or increase the injection pressure.

Implementation of the electrohydraulic effect (Yutkin effect) by means of an electric discharge nozzle (EDN) is one of the ways to considerably increase the injection pressure.

For injecting the fuel dose into the combustion chamber (CC) in the EDN, use is made of the electrohydraulic discharge (EHD). For this purpose the arc discharge of the charge accumulated in the high-voltage energy accumulator (HVEA) is performed in internal space before nozzle jets.

The EDN is an object of research over a period of several years due to its many possible advantages, such as:

1. Simplicity of design (for production, after final optimization).

2. Absence of parts, which need extended precision of manufacture (as in case with storage battery-operated fuel injection systems).

3. Possibility of obtaining the considerably higher injection pressures within considerably shorter (up to two orders of magnitude) injection time and thereby improved spraying, obtaining the substantial part of fuel in gaseous state, splitting the part of fuel heavy molecules, obtaining the radicals of fuel molecules.

4. Possibility of realizing considerably better high-frequency operation of the ICE (diesels in particular) due to the fast powerful injection and low sluggishness of the injection process.

5. Improved efficiency and environmental compatibility due to the pressure increase and fast combustion of the charge.

Nevertheless, nothing is known so far about development of the functional designs of the EDN and much less about electrohydraulic fuel injection (EHFI) systems.

Known from the technical level is a device for electrohydraulic spraying of liquid fed into nozzle body internal space (chamber) under slight pressure and flowing from the body through nozzle orifice when electric-spark discharge [4] is created after nozzle orifice. In this event, as the flow jet crosses the plane, in which electrodes are arranged, an electrohydraulic impact occurs in the passing flow jet as a result of electric-spark breakdown. Under action of the impact the liquid disintegration takes place and high-velocity flow of fine droplets is formed.

Melioration is declared as application field of the device.

A spray injector is known, in which the discharge is performed inside the injector upstream of the nozzle in order to obtain finely dispersed high-velocity flow of liquid particles and a check valve preventing the passage of compression waves into fuel inlet line of the spray injector is introduced in order to increase discharge energy fraction intended for jet spraying.

A device for electrohydraulic spraying of liquid is known, which consists of the body with the nozzle extension and fuel inlet branch pipe with a discharge unit arranged in it, in which one of electrodes has a concave surface for enhancing the spraying effectiveness and is made movable with a purpose of concentrating the compression waves in the direction of outlet nozzle jet, including the use of this electrode as a check valve [5]. Heat and mass exchange has been declared as application field of these devices.

Considered as drawbacks of the above-mentioned devices with reference to their possible use as fuel injectors are: absence of control of injected fuel dose; no provision of stable conditions of consequent breakdowns; no decisions intended to prevent sippage of the liquid being sprayed and contamination of the injected dose of liquid by gases from previous spraying; great buffer volume of liquid in the discharge zone and after it, impeding the obtainment of high fuel injection parameters (injection pressure and time); insufficient use of discharge products.

Method of electric-pulse liquid spraying and device for its implementation are most close to the present invention [6]. The purpose of the method and device with reference to the above-mentioned devices consists in prevention of presence of liquid and electric-spark discharge interaction products in the flow jet of sprayed liquid because such products allegedly inhibit the use of this device as a fuel injecting nozzle in the ICE. To realize this purpose the electric-spark discharge is created in liquid stream constantly flowing at a speed of 5 m/s in the direction perpendicular to the axis of the nozzle orifice arranged on the nozzle body end face, whereas the high-voltage electric field vector is directed parallel to the nozzle orifice axis. Liquid is supplied through coaxial channel in the central electrode and drained through an additional branch pipe. Fuel injection into the ICE is declared as application field of the devices designed in compliance with this patent.

Such device has the following disadvantages.

Firstly, as it is evident from the description to this patent and from engineering solution, the question is about all products of the said interaction. However, as it is known [7], one of the electrohydraulic spraying effects consists in the transformation of sprayed fuel chemical composition (breaking of heavy molecules, formation of radicals), ensuring fast and complete combustion of the fuel. It is obvious that gases, formed as a result of the discharge, are undesirable in particular as regards the provision of stable conditions of subsequent breakdowns. The other discharge products should be delivered to the fuel combustion zone. The liquid pumping rate (no less than 5 m/s) is unjustified and, obviously, can be considerably lower.

Secondly, the device made in compliance with this patent, as well as other above-mentioned devices, there is no control of the injected fuel dose and any solutions aimed at prevention of sprayed liquid sippage before and after discharge. Both are required to ensure trouble-free and efficient operation of engines.

Thirdly, the device made in compliance with this patent has large buffer volume of liquid between the discharge zone and nozzle orifice outlet, besides, the compression waves should change their direction approximately by 90° in order to come to the nozzle. All this does not allow obtaining high fuel injection parameters (injection pressure, time and moments, injection frequency).

Fourthly, in the device made in compliance with the present patent the shut-off valve installed in the nozzle orifice and intended to provide for high intensity and quality of spraying, presents inertial and power-consuming mechanism having certain initial locking strength and additionally supported by pressure from the combustion chamber. The shut-off valve is opened directly by the injected fuel flow jet; therefore, such valve absorbs some portion of the flow jet energy and impairs the achievement of high injection parameters. Besides, the shut-off valve is closed before the discharge moment and creates the reverse compression wave thus impairing the injection parameters until the moment of the valve opening.

### SUMMARY OF THE INVENTION

The purpose of the present invention consists in providing the method of electrohydraulic fuel injection (EHFT) ensuring trouble-free, more efficient, environmentally compatible and stable operation of different classes of engines with high injection parameters.

The purpose of version 1 is attained in the electropulse spraying method, which includes the liquid flow jet forcing through the nozzle orifice when creating the electric-spark discharge in the liquid flow, by arranging the inlets of nozzle channels along the lines passing between discharge surfaces of electrodes.

The purpose of version 2 is attained in the electropulse spraying method, which includes the liquid flow jet forcing through the nozzle orifice when creating the electric-spark discharge in the liquid flow, the nozzle channels are opened before the EHD and closed after fuel injection, the process of nozzle channels opening and closing is controlled.

The purpose of version 3 is attained in the electropulse spraying method, which includes the liquid flow jet forcing through the nozzle orifice when creating the electric-spark discharge in the liquid flow, by pumping the fuel inside the electric discharge nozzle, at least between electrodes and the pressure of the pumped fuel is maintained close to the pressure in the injection volume.

The purpose of version 4 is attained in the electropulse spraying method, which includes the liquid flow jet forcing through the nozzle orifice when creating the electric-spark discharge in the liquid flow, through controlling the injected fuel dose by variation of distance between the end face of the high-voltage electrode and grounded electrode and (or) variation of discharge energy.

The purpose of version 5 is attained in the electropulse spraying method, which includes the liquid flow jet forcing through the nozzle orifice when creating the electric-spark discharge in the liquid flow, by exposing the fuel to cleaning from gases and some other discharge products in fuel to provide for permanent and high characteristics of the fuel.

The purpose of version 6 is attained in the electropulse spraying method, which includes the liquid flow jet forcing through the nozzle orifice when creating the electric-spark discharge in the liquid flow, by connecting the high-voltage commutator into electric circuit for provision of electric discharge nozzle operation in order to obtain high parameters of voltage from the HVEA (delay, duration, slope, frequency).

### BRIEF DESCRIPTION OF THE DRAWINGS

FIG. 1 shows a scheme of an electrohydraulic fuel injection;

FIG. 2 shows an electric discharge nozzle (EDN);

FIG. 3 shows an electrical circuit for provision of operation of the EDN;

FIG. 4 shows the EDN hydraulic valve;

FIG. 5 shows a pressure regulator inside the inner cavity of the EDN.

### THE BEST EMBODIMENT OF THE INVENTION

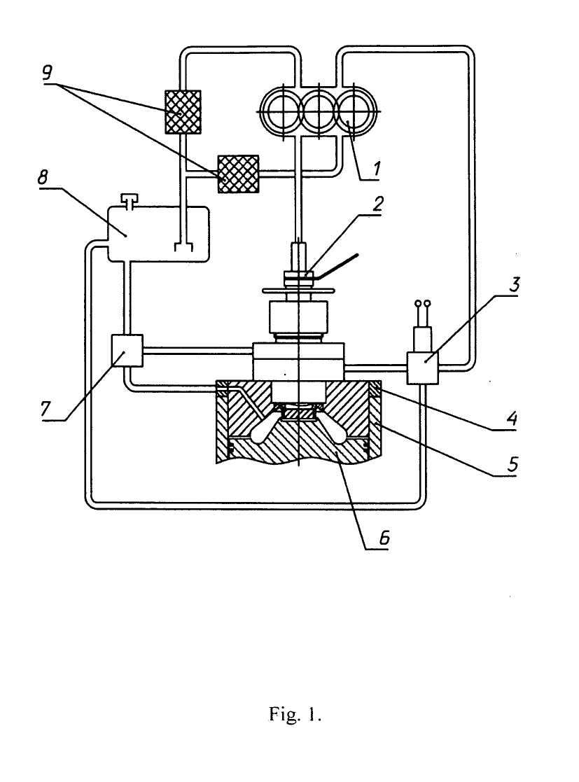

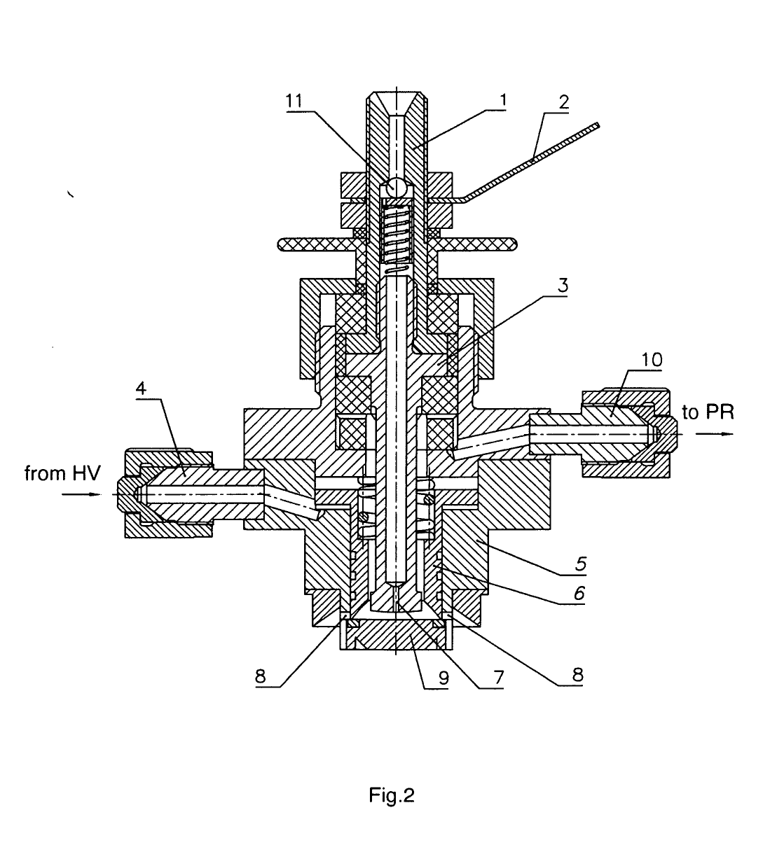

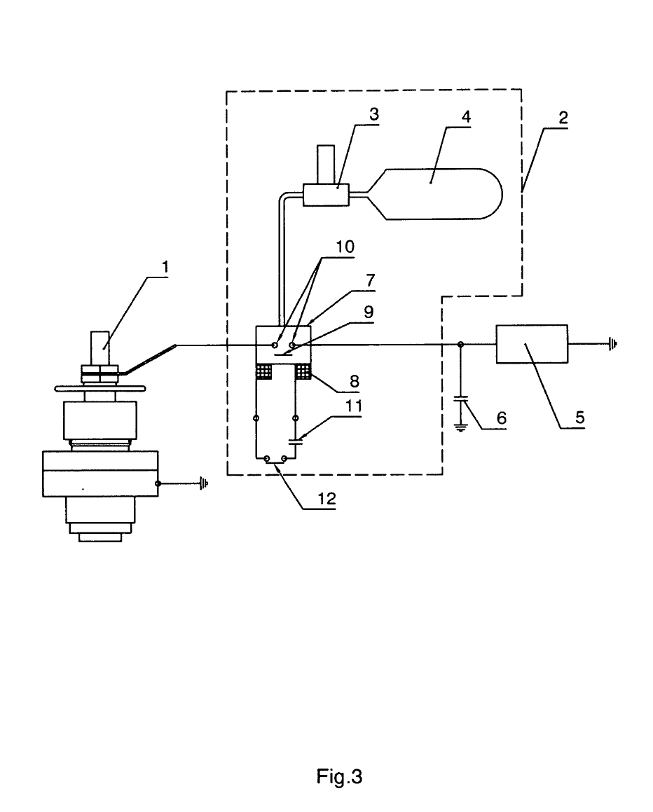

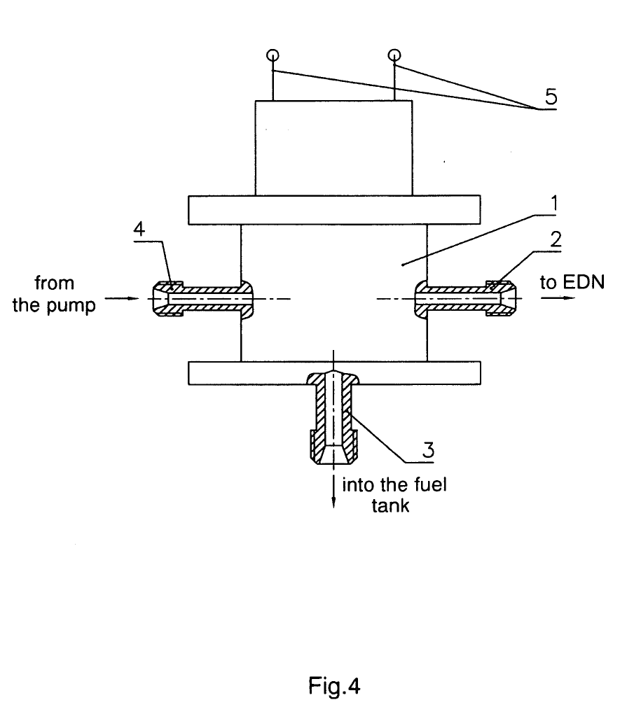

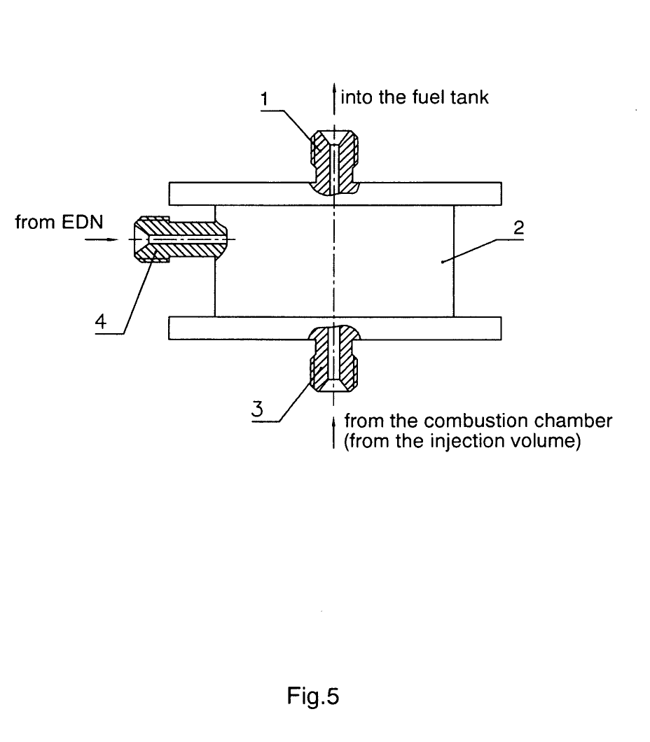

The version of the electric circuit for implementation of proposed electrohydraulic fuel injection methods (FIG. 1) comprises: electric discharge nozzle (EDN) 2 (FIG. 2); hydraulic valve (HV) 3 for opening and closing nozzle channels of the electric discharge nozzle (FIG. 4); pressure regulator (PR) 7 inside the inner cavity of the nozzle (FIG. 5); fuel tank 8; fuel filters 9 (filtering devices) for general cleaning of fuel and for cleaning the latter from gases and other discharge products in the fuel; fuel pump 1; electrical circuit (EC) for provision of operation of the EDN (not shown in FIG. 1) (FIG. 3).

The electric discharge nozzle (FIG. 2) provides for the EHD and includes high-voltage electrode 12 with high-voltage electrode connection 10, contact plate 11, inlet connection 13, electric discharge nozzle body 14 with nozzle channels 17, shut-off valve 15, high-voltage electrode channel 16, grounded electrode 18, shut-off valve 15, outlet connection 19, check valve 20.

The hydraulic valve (FIG. 4) provides for activation and deactivation of EDN shut-off valve 15 intended for preliminary opening of the nozzle channels directly before EHD and their closing immediately after fuel injection and comprises valve 33 with contacts, which provides the activation of electromagnet valve 37 (or with inlet connections for hydraulic or pneumatic drive of the valve, these versions are not shown in FIG. 4), outlet connection 34, drain connection 35 and inlet connection 36.

The pressure regulator (FIG. 5) maintains pressure of the fuel, pumped inside the electric discharge nozzle, close to the pressure above the piston (in the injection volume) and includes drain connection 38, body 39 with the valve, receiving connection 40 connected with the injection volume and receiving connection 41 connected with the EDN.

The fuel filters (filtering devices) are intended for general cleaning of fuel and cleaning of the latter from gases and some other discharge products in the fuel.

The fuel electrohydraulic injection method is implemented in the following manner.

1. In the initial position (piston is far from TDC, pressure in the injection volume is relatively low) nozzle channels 17 of the EDN are closed. In this case, delivered from the fuel pump to high-voltage electrode connection 10 is the fuel under pressure, which passes through high-voltage electrode 12 via channel 16 and further via EDN outlet connection 19 to PR inlet connection 41.

In the PR the fuel flows through valve 39 into drain connection 38 and further to the fuel tank.

The fuel from the fuel tank is delivered under pressure to inlet connection 36 of the HV, but valve 33 is open and the fuel mainly is discharged into the fuel tank through drain connection 35 of the HV; in this case, a small quantity of fuel at a low pressure is delivered to the hydraulic valve outlet connection incapable to perform operation in the electric discharge nozzle communicated with this connection by means of inlet connection 13 to lift shut-off valve 15 of the EDN.

Pulse operation of the fuel pump is possible when pressure pulses from the fuel pump are delivered to the EDN by the moments of opening of the EDN shut-off valve (this version and its control are not shown in the drawings).

2. As the piston approaches the TDC (with pressure in the injection volume increasing), before the electrohydraulic discharge starts, pressure in receiving connection 40 of the PR increases, valve 39 of the PR follows up this pressure and decreases the section for passage of the fuel to be drained through drain connection 38 of the PR into the fuel tank, pressure in inlet connection 41 of the PR and, respectively, in EDN outlet connection 19 and inside the EDN increases and is maintained close to the pressure in the combustion chamber (in the injection volume). This prevents possible fuel seepage from the EDN into combustion chamber and ingress of gas from the combustion chamber (injection volume) into the EDN.

3. Immediately prior to EHD (with relatively high pressure in the injection volume) an electric pulse is transmitted to the contacts of HV electromagnet 37 of the drive of HV valve 33 (or pressure pulse is transmitted to valve 33 of the HV for hydraulic or pneumatic drive of the valve, these versions and their control are not illustrated in FIG. 4), as a result valve 33 of the HV closes the way to HV drain connection 35 for the fuel coming from the pump through HV inlet connection 36 and directs the fuel into HV outlet connection 34 connected with EDN inlet connection 13, through which the fuel is delivered under EDN shut-off valve 15. In this manner the shut-off valve spring force is overcome, shut-off valve 15 is lifted opening nozzle channels 17 of the EDN.

4. In the event of the EHD, the voltage from the HVEA, causing the breakdown in liquid between the end face of high-voltage electrode 12 and grounded electrode 18 right near the channel of high-voltage electrode 16 (which is achieved by the high-voltage electrode predetermined shape), is delivered to EDN electrode 12 through the contact plate of high-voltage commutator 22 of the EC providing for operation of the EDN (FIG. 3). Moving upward through the electrode channel, the compression wave causes check valve 20 to block the channel, which prevents the compression wave from entering connection 10 of the EDN high-voltage electrode and further the EDN fuel supply line. Moving along the main propagation direction of the compression waves formed during the EHD (along the lines, passing between discharge surfaces of electrodes), the compression waves cause the injection of fuel and EHD products through open nozzle channels into the cylinder (injection volume).

The injected fuel dose is controlled by variation of distance between the end face of EDN high-voltage electrode 12 and EDN grounded electrode 18 and (or) variation of the discharge energy.

The EHD terminates before the voltage from the high-voltage energy accumulator on high-voltage electrode 12 is exhausted and is determined by the accumulator energy and discharge circuit parameters.

The state of the HV and PR is identical with that described in Item 3.

5. After the EHD terminates, HV contacts 37 are deenergized (or pressure pulse on HV valve 33 for hydraulic or pneumatic drive of the valve is cancelled, these versions and their control are not shown in FIG. 4), as a result, valve 33 opens for the fuel, coming from the fuel pump through HV inlet connection 36, the way to the fuel tank through HV drain connection 35 thus reducing the pressure delivered through HV outlet connection 34 and EDN inlet connection 13 under EDN shut-off valve 15 (during fuel tank pulse operation—pulse termination and pressure drop under EDN shut-off valve 15). As a result the spring of EDN shut-off valve 15 closes nozzle channels 17 of the EDN.

EDN check valve 20 opens the channel of high-voltage electrode 16, the fuel under high pressure flows through the electrode channel, discharge zone, channels in the EDN structure to EDN outlet connection 19 and carries the fuel, saturated with gas and other discharge products, from the EDN discharge zone and from the zone around it into the fuel tank. The liquid flow velocity, necessary for sufficient cleaning of the EDN from gas-saturated EHD products, is determined by the distance between the axis of EDN high-voltage electrode 12 and EDN shut-off valve 15 within which the fuel should be changed with fresh (refined) one between discharges and by the time between discharges.

As the piston travels from the TDC (when pressure in the injection volume decreases), pressure in PR receiving connection 40 gradually drops, PR valve 39 follows up this pressure increasing the section for passing the fuel to be drained through PR drain connection 38 into the fuel tank, simultaneously the pressure in PR inlet connection 41 and, respectively, inside the EDN proper drops and is maintained close to the pressure in the combustion chamber (in the injection volume). This prevents possible fuel sippage from the EDN into combustion chamber (in the injection volume) and ingress of gas into the EDN from the combustion chamber (injection volume).

Further the fuel injection system operation process is repeated as described in Items 1 to 5. Such a process is characteristic of internal combustion engines and of periodic combustion gas-turbine engines and power plants (GTE and GTPP) (at ν=const). When applying the'proposed method to GTE (GTPP) with conventional cycle (at ρ=const) and to various boiler plants, there is no necessity to consider the pressure increasing-decreasing processes in the injection volume and, respectively, in the pressure regulator (PR), in all other respects the operation is similar.

The electric circuit for providing the operation of the EDN (FIG. 3) supplies the voltage from the HNEA (only capacitance energy accumulator 26 connected with high-voltage unit 25 is shown in FIG. 3) to EDN high-voltage electrode 10. Electric pulses (voltage) to PR electromagnet contacts 37 (or pressure pulses to HV valve 33 for the valve hydraulic or pneumatic drive, these versions are not shown in FIG. 4) are delivered in compliance with the parameters (delay, voltage, duration, slope, frequency) preset by the EHFI control system (CS) or by the CS of the plant where the EHFI is implemented (not shown in FIGS. 1, 3) at the preset by the control systems time moments. Fuel pump pulse operation is also controlled by the EHFI CS and (or) plant CS where the EHFI is implemented and (or) is ensured by the respective drives from the engine crankshaft. High-voltage commutator 22 (FIG. 3), comprising, for instance, movable contact 29 and fixed contact 30 arranges in body 27, induction coil 28, capacitor 31, gas reducer 23 and gas bottle 24, is connected to the EC for providing the EDN operation in order to ensure the required parameters of the voltage (delay, duration, slope, frequency) from the HVEA. High-voltage commutator 22 is actuated by shorting key 32.

### INDUSTRIAL APPLICABILITY

The proposed method of the electrohydraulic fuel injection realizes the above-mentioned advantages, providing the possibility of efficient, and environmentally compatible operation of diesel internal combustion engines at considerably higher (up to several times) revolutions per minute than those achieved in the present time. The electric circuit for providing the electric discharge nozzle operation and the electrohydraulic fuel injection system as a whole make it possible to realize, if necessary, multiple fuel injections within the operating cycle.

The proposed method may be used in all types of the internal combustion engines, gas turbine engines and power plants (GTE and GTPP) both of periodic combustion (at ν=const) and of those employing conventional combustion cycle (at ρ=const), in various boiler plants, and also for spraying other liquids when necessity arises to use the above-described advantages of the EHD, when powerful flows of finely dispersed and (or) transformed in the process of liquid discharges are required.

### INFORMATION SOURCES

1. Internal Combustion Engines. Book 1. Theory of Operation Processes. Handbook for higher education institution/Edited by V. N. Lukin—Moscow: Vysshaya shkola, 2005.
2. Control Systems of Diesel Engines. Translation from German—Moscow: “Za Rulyom” Book and Magazine Publishing House JSC, 2004.
3. Internal Combustion Engines. Volume I. Operation Processes in Engines and Their Accessories. Edited by Professor A. S. Orlin—Moscow: Mashgiz, 1957.
4. USSR Authorship Certificate No. 1041162, cl. B05B 5/06, 1983.
5. USSR Authorship Certificate No. 1087186, 1984.
6. Patent of RF No. 2108870, B05B 5/00, F02M 57/00, 1996.
7. Yutkin L. A. Electrohydraulic Effect and Its Application in Industry—Leningrad: Mashinostroyeniye, 1986.

1. Method of electrohydraulic fuel injection including the liquid jet forcing through the nozzle orifice when creating the electric-spark discharge in the liquid flow wherein the inlets of nozzle channels are arranged along the lines passing between discharge surfaces of electrodes.

2. Method of electrohydraulic fuel injection including the liquid jet forcing through the nozzle orifice when creating the electric-spark discharge in the liquid flow wherein the nozzle channels are opened before the EHD and closed after fuel injection, process of nozzle channels opening and closing is controlled.

3. Method of electrohydraulic fuel injection including the liquid jet forcing through the nozzle orifice when creating the electric-spark discharge in the liquid flow wherein the fuel inside the electric discharge nozzle is pumped, at least between electrodes, and pressure of the pumped fuel is maintained close to the pressure in the injection volume.

4. Method of electrohydraulic fuel injection including the liquid jet forcing through the nozzle orifice when creating the electric-spark discharge in the liquid flow wherein injected fuel dose is controlled by variation of distance between the end face of the high-voltage electrode and grounded electrode and (or) variation of discharge energy.

5. Method of electrohydraulic fuel injection including the liquid jet forcing through the nozzle orifice when creating the electric-spark discharge in the liquid flow wherein to provide for permanent and high characteristics of fuel, it is exposed to cleaning from gases and some other discharge products in fuel.

6. Method of electrohydraulic fuel injection including the liquid jet forcing through the nozzle orifice when creating the electric-spark discharge in the liquid flow wherein to provide for necessary parameters of voltage from the high-voltage energy accumulator (delay, voltage, slope, frequency), the high-voltage commutator comprising at least movable and fixed contacts, induction coil, capacitor, gas reducer and gas bottle, is connected into the electric circuit for provision of operation of the electric discharge nozzle.
